(19) United States
(12) Patent Application Publication
(10) Pub. No.: US 2006/0269207 A1
(43) Pub. Date: Nov. 30, 2006

(54) Information technology communications cabinet for electrical substation communications

(75) Inventor: Niksa Ivancevic, Milwaukee, WI (US)

Correspondence Address: GODFREY & KAHN S.C., 780 NORTH WATER STREET, MILWAUKEE, WI, 53202, US

(73) Assignee: CableCom, LLC

(21) Appl. No.: 11/141,766

(22) Filed: May 31, 2005

(51) Int. Cl. G02B 6/00

(52) U.S. Cl. 385/135

(57) ABSTRACT

An information technology communications cabinet for electrical substation communications. The cabinet preferably includes an interior defined by a top, a bottom, a back wall, a pair of sidewalls, a front flange and a removable door. A plurality of network and communications equipment is mounted in the interior of the enclosure. Extending from the top of the cabinet are a plurality of connectors connecting to conduits with cabling to and from the equipment installed within the enclosure for connection to and from the power network. The cabinet further includes a plurality of mounting brackets and mounting straps attached to vertical mounting channels and sidewalls of the cabinet for mounting the network and communications equipment thereto.

### BACKGROUND OF THE INVENTION

The present invention relates generally to electrical substation communications equipment, and more particularly to an information technology communications enclosure for electrical substation communications.

Electric power substations have been utilized in the electrical utility industry and primarily in the transmission and distribution areas thereof for the supplying of electrical power for many years. Substations are a vital part of essential public services and usually consist of equipment that boosts or reduces outputs from a power generator, equipment for collecting and distributing electric power, equipment for controlling power flow, and equipment for protecting and controlling other equipment in the substation.

Substation communications frequently employ an enclosure or cabinet mounted at a convenient location in a facility to provide interconnection between fiber optic conductors and copper conductors. Substation communications involve connecting devices that need to communicate, and moving data from distributed relays, RTUs (Remote Terminal Units), PLCs (Programmable Logic Controllers) and IEDs (Intelligent Electronic Devices) to a central control area.

Ethernet is becoming the preferred communications vehicle within substations. Ethernet is used for control, protection and metering. Most substations, as they install Ethernet, use combinations of fiber optic cabling and copper cabling.

Ethernet and fiber optic cabling are used in substation communication applications. Ethernet with fiber optic cabling has many benefits for power utility substations. Fiber optic cabling is an enabling technology for extending Ethernet into power utility substations because of its immunity to electrical interference, its avoidance of ground loops, its virtually limitless bandwidth, and its capability for extended-distance applications. Fiber optic cabling is also highly noise resistant and easier to work with in high-voltage environments. It also is better adaptable to the industry's requirement for transmission over relatively long distances, and offers the most cost-effective upgrade path to higher bandwidths as they become necessary.

Ethernet generally requires fiber optic cable and category 5 twisted-pair copper cabling with RJ-45 connectors. Although not noise immune like fiber optic cabling, copper cabling can be used in Ethernet systems for the short runs inside of control room cabinets where there is protection from EMI noise.

The present invention provides an information technology communications cabinet for electrical substation communications that is not disclosed in the prior art.

### SUMMARY OF THE INVENTION

The present invention is a communications cabinet which provides an enclosure for Ethernet network equipment and cable connections and terminations. An information technology network enclosure for electrical substation communications. The cabinet preferably includes an interior defined by a top, a bottom, a back wall, a pair of sidewalls, a front flange and a removable door. The cabinet is preferably mounted to a wall or other fixed structure in a control room. A plurality of network and communications equipment is mounted in the interior of the enclosure. Extending from the top of the cabinet are a plurality of connectors connecting to conduits with cabling to and from the equipment installed in the enclosure for connection to and from the power network.

The cabinet further includes a plurality of mounting brackets adjustably attached to vertical mounting channels attached to the back wall of the cabinet for mounting the network and communications equipment thereto. The cabinet still further includes a plurality of stand-off mounting straps attached to the vertical mounting channels of the cabinet for mounting horizontal components thereto and for possible securing fiber optic service coil to the inside of the stand-off member. The cabinet yet further includes a plurality of side mounting straps attached to the inner sidewalls of the cabinet for accepting rack mount hardware thereon.

Various other features, objects and advantages of the invention will be made apparent to those skilled in the art from the accompanying drawings and detailed description thereof.

### BRIEF DESCRIPTION OF THE DRAWINGS

FIG. 1 is a front view of an information technology communications cabinet with the door removed for electrical substation communications in accordance with an embodiment of the present invention;

FIG. 2A is a front plan view of the communications cabinet of FIG. 1 with the door and electrical components removed;

FIG. 2B is a top plan view of the communications cabinet of FIG. 2A;

FIG. 2C is a right side plan view of the communications cabinet of FIG. 2A;

FIG. 3A is a front plan view of a removable door for the communications cabinet of FIGS. 1, 2A, 2B and 2C;

FIG. 3B is an enlarged partial rear plan view of the upper portion of the removable door of FIG. 3A;

FIG. 4A is a side plan view of a mounting bracket for use in the communications cabinet of FIGS. 1, 2A, 2B and 2C;

FIG. 4B is a top plan view of the mounting bracket of FIG. 4A;

FIG. 4C is a front plan view of the mounting bracket of FIG. 4A;

FIG. 5A is a front plan view of an embodiment of a mounting strap for use in the communications cabinet of FIGS. 1, 2A, 2B and 2C;

FIG. 5B is a top plan view of the mounting strap of FIG. 5A;

FIG. 6A is a front plan view of another embodiment of a mounting strap for use in the communications cabinet of FIGS. 1, 2A, 2B and 2C;

FIG. 6B is a top plan view of the mounting strap of FIG. 6A;

FIG. 7A is a front plan view of an embodiment of a side mounting strap for use in the communications cabinet of FIGS. 1, 2A, 2B and 2C; and

FIG. 7B is a top plan view of the side mounting strap of FIG. 7A.

### DETAILED DESCRIPTION OF THE INVENTION

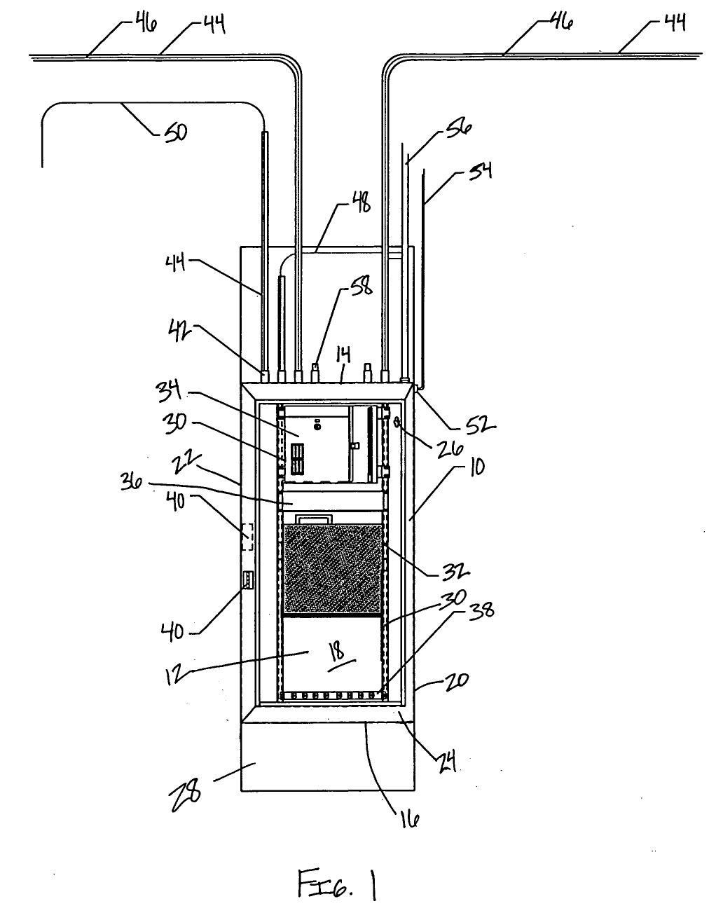

Referring now to the drawings, FIG. 1 is a front view of an information technology communications cabinet 10 with the door removed for electrical substation communications in accordance with an embodiment of the present invention. FIG. 1 shows the wall-mountable cabinet 10 with the front door removed. The cabinet 10 is generally rectangular and includes an interior 12 defined by a top 14, a bottom 16, a back wall 18, a pair of sidewalls 20, 22 and a front flange 24. The back wall 18 in the cabinet interior 12 includes a plurality of apertures 26 which allows mounting of the cabinet 10 to a wall or other fixed structure, such as a wall in a control room with fasteners. In a preferred embodiment, the cabinet 10 is preferably mounted to a fire resistant backboard 28 that is mounted to a wall. A plurality of network and communications equipment is mounted in the interior of the enclosure and cabling is run from the enclosure to the power network. The back wall 18 of the cabinet 10 preferably includes a plurality of vertical mounting channels 30 attached thereto for mounting the network and communications equipment by fasteners at a plurality of interchangeable locations. The equipment mounted in the interior 12 of the cabinet 10 preferably includes Ethernet equipment 32, a fiber optic termination panel 34, cable management equipment 36, and a surge suppressing power strip 38. Mounted within the front flange 24 of the cabinet 10 is at least one multi-port network access module 40 for accepting a plurality of patch cables.

Extending from the top 14 of the cabinet 10 are a plurality of connectors 42 connecting to conduits 44 with cabling inside for connection to the power network. The conduits 44 typically include fiber optic cable 46, Ethernet cable 48, or other network cable 50 running through them from the equipment in the cabinet 10 to the power network. An external ground lug 52 is connected to the cabinet 10 and includes a grounding wire 54 running from the cabinet 10 to the building grounding system for grounding the cabinet 10. Another conduit 56 extends from the top 14 of the cabinet 10 with an AC supply from the RTU inverter. Still another conduit may include an AC or DC supply for TELCO applications. Connectors 42 that are not connected to conduits have plugs 58 installed therein.

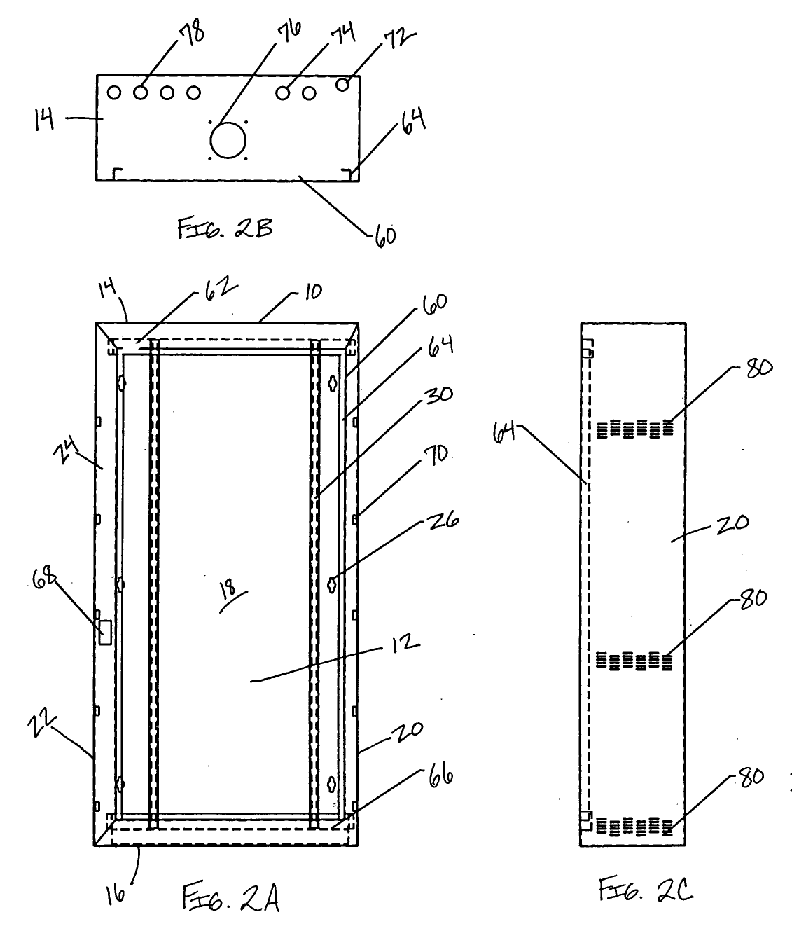

FIG. 2 shows various views of the communications cabinet 10 of FIG. 1. The communications cabinet 10 is preferably made of an aluminized steel or other type of metal normally used for network and/or communications equipment enclosures.

FIG. 2A is a front plan view of the communications cabinet 10 of FIG. 1 with the door, cabling and electrical components removed. The cabinet 10 preferably includes an opening 60 in the front for receiving a removable door therein. The top portion of the front flange 24 preferably includes an open channel 62 attached thereto for receiving the removable door. The side portion of the front flange 24 preferably includes a side channel 64 for receiving the removable door. The bottom portion of the front flange 24 preferably includes a closed channel 66 attached thereto for receiving the removable door. At least one cut-out 68 preferably extends through the front flange 24 for receiving a multi-port network access module therein. The cabinet 10 further includes a plurality of side mounting straps 70 attached to the inner sidewalls 20, 22 of the cabinet 10 for accepting rack mount hardware thereon.

FIG. 2B is a top plan view of the communications cabinet 10 of FIG. 2A. A plurality of openings extend through the top 14 of the communications cabinet 10. There is at least one opening 72 extending through the top 14 of the cabinet 10 for a conduit connector to provide electrical power to the cabinet 10. There is at least one opening 74 extending through the top 14 of the cabinet 10 for a conduit connector for routing fiber optic cable 46 to the fiber optic termination panel 34 within the cabinet 10. There is at least one opening 76 extending through the top 14 of the cabinet 10 for mounting a fan assembly therein. There is at least one opening 78 extending through the top 14 of the cabinet 10 for routing Ethernet cable 48 from the router 32 within the cabinet 10 and for routing fiber optic jumper cable 46 from the fiber optic termination panel 34 within the cabinet 10.

FIG. 2C is a right side plan view of the communications cabinet 10 of FIG. 2A. The sidewalls 20, 22 preferably include a plurality of slotted vent openings 80 formed therein for air draw through the cabinet 10.

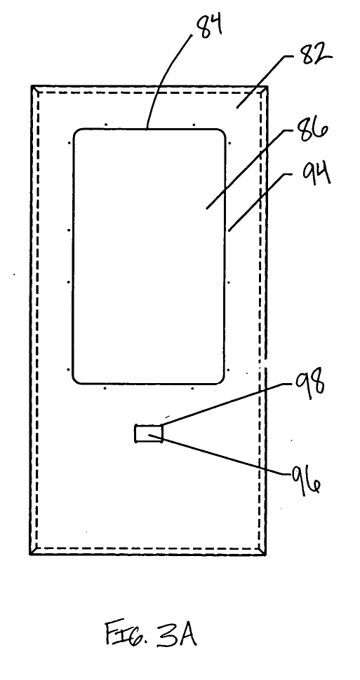

FIG. 3A is a front plan view of a removable door 82 for the communications cabinet of FIGS. 1, 2A, 2B and 2C. The door 82 is preferably made of an aluminized steel or other type of metal normally used for network and/or communications equipment enclosures. The door 82 preferably includes a large opening 84 extending therethrough for accepting a window 86 therein. The window 86 is preferably made of glass, plexi-glass or other suitable plastic material.

FIG. 3B is an enlarged partial rear plan view of the upper portion of the removable door 82 of FIG. 3A. As shown in FIG. 3B, the window 86 is preferably attached to the door 82 around the periphery of the opening 84 with a plurality of beveled mounting plates 88 that are fastened to the door 82 around the periphery of the opening 84 with fasteners 92. The mounting plates 88 preferably include at least two holes 90 for accepting the fasteners 92. There are also a plurality of holes 94 in the door 82 around the periphery of the opening 84 for accepting the fasteners 92 and securing the window 86 in the opening 84 in the door 82. The bevel in the mounting plates 88 allows for securing various thicknesses of window within the opening 84 of the door 82.

Referring again to FIG. 3A, the door 82 also preferably includes a smaller opening 96 below the window opening 84 for accepting a handle 98 therein. The handle 98 is preferably attached to the door 82 with fasteners.

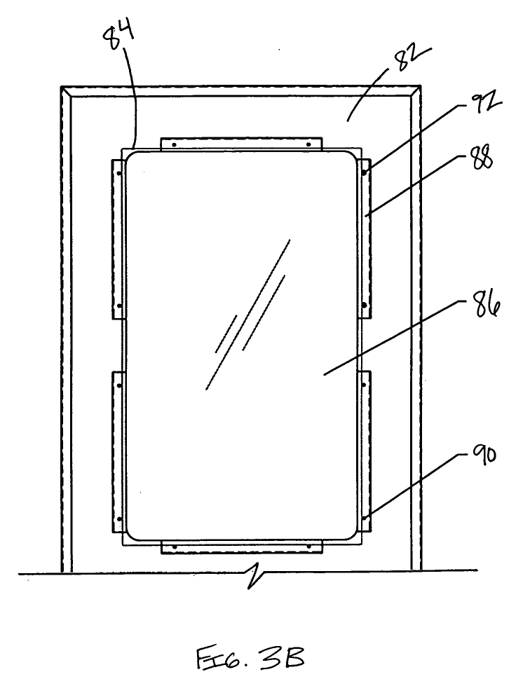

FIG. 4A is a side plan view of a mounting bracket 100 for adjustable attachment to the vertical mounting channels 30 attached to the back wall 18 of the cabinet 10 for mounting network and communications equipment thereto. FIG. 4B is a top plan view of the mounting bracket 100 of FIG. 4A. FIG. 4C is a front plan view of the mounting bracket 100 of FIG. 4A. The adjustable mounting bracket 100 is preferably made of aluminized steel or other type of metal. The mounting bracket 100 is preferably triangularly-shaped with a top member 102 and two triangularly-shaped, spaced-apart side members 104. 106 extending downwardly from opposite sides of the top member 102 for an open channel construction. The two spaced-apart side members 104, 106 each include at least one attachment hook 108 extending from a rear side 112 of each spaced-apart side member 104, 106 for removable attachment in slots of the vertical mounting channel 30. There is a notch 110 between the hook 108 and the rear side 112 of the side members 104, 106 for resting on the bottom of a channel slot. The top member 102 preferably includes a plurality of openings 114 extending therethrough for receiving fasteners for attaching network and communications equipment to the bracket 100.

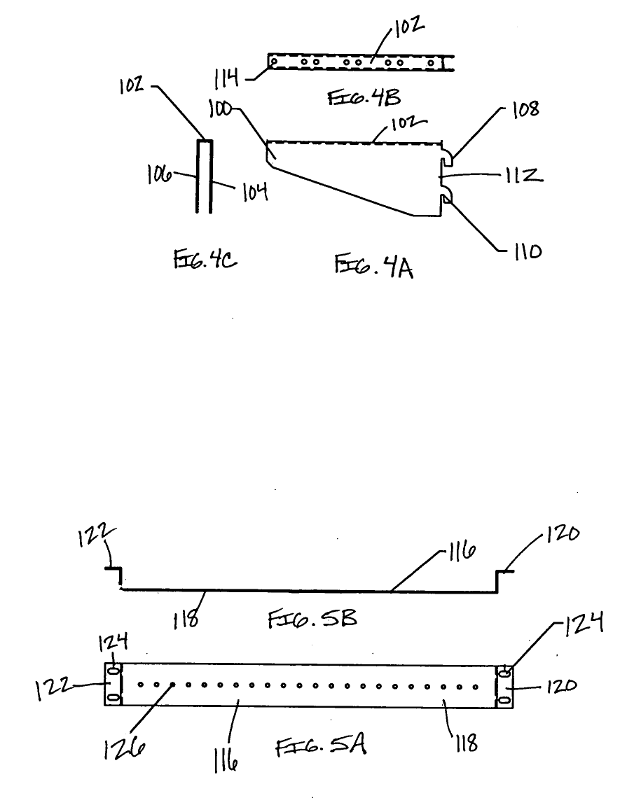

FIG. 5A is a front plan view of an embodiment of a mounting strap 116 for use in the communications cabinet 10 of FIGS. 1, 2A, 2B and 2C. FIG. 5B is a top plan view of the mounting strap 116 of FIG. 5A. The mounting strap 116 is preferably made of aluminized steel or other type of metal. The mounting strap 116 is preferably a stand-off mounting strap for mounting horizontal components thereto. The mounting strap 116 preferably includes a stand-off member 118 and two end members 120, 122 at opposite ends of the stand-off member 118. The two end members 120, 122 each include at least one slotted opening 124 extending therethrough for adjustable attachment of the mounting strap 116 to the vertical mounting channels 30. The stand-off member 118 preferably includes a plurality of openings 126 extending therethrough for receiving fasteners for attaching network and communications equipment to the mounting strap 116.

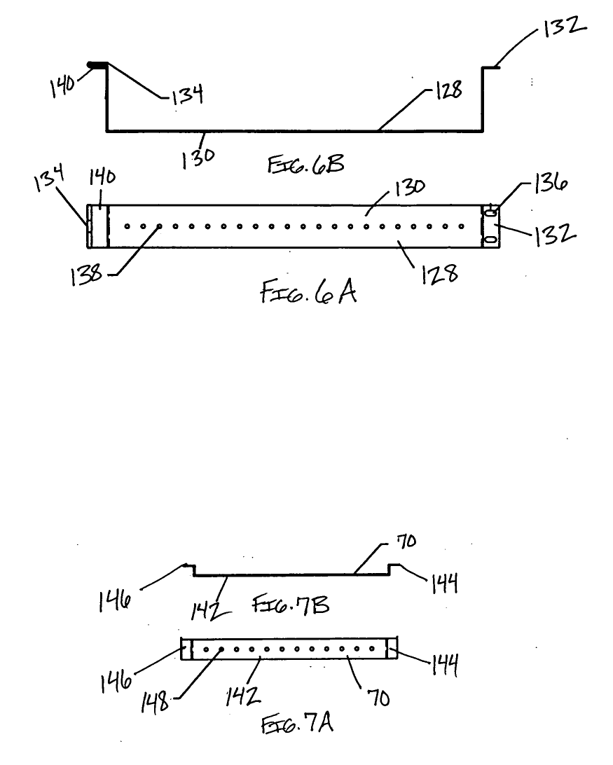

FIG. 6A is a front plan view of another embodiment of a mounting strap 128 for use in the communications cabinet 10 of FIGS. 1, 2A, 2B and 2C. FIG. 6B is a top plan view of the mounting strap 128 of FIG. 6A. The mounting strap 128 is preferably made of aluminized steel or other type of metal. The mounting strap 128 is preferably a stand-off mounting strap for securing a fiber optic service coil to the inside of the stand-off member 130 and for possibly mounting horizontal components thereto. The mounting strap 128 preferably includes a stand-off member 130 and two end members 132, 134 at opposite ends of the stand-off member 130. A first end member 132 includes at least one slotted opening 136 extending therethrough for adjustable attachment of the first end member 132 to one of the vertical mounting channels 30. A second end member 134 preferably includes a hinged mounting plate 140 for pivotally securing the mounting strap 128 to the other vertical mounting channel 30. The stand-off member 130 preferably includes a plurality of openings 138 extending therethrough for receiving fasteners for attaching network and communications equipment to the mounting strap 128.

FIG. 7A is a front plan view of an embodiment of a side mounting strap 70 for use in the communications cabinet 10 of FIGS. 1, 2A, 2B and 2C. FIG. 7B is a top plan view of the side mounting strap 70 of FIG. 7A. The cabinet 10 preferably includes a plurality of side mounting straps 70 attached to the inner sidewalls 20, 22 of the cabinet 10 for accepting rack mount hardware thereon. The side mounting strap 70 is preferably made of aluminized steel or other type of metal. The side mounting strap 70 is preferably a stand-off mounting strap for mounting horizontal components thereto. The side mounting strap 70 preferably includes a stand-off member 142 and two end members 144, 146 at opposite ends of the stand-off member 142. The stand-off member 142 preferably includes a plurality of openings 148 extending therethrough for receiving fasteners for attaching network and communications equipment to the side mounting strap 70.

While the invention has been described with reference to preferred embodiments, those skilled in the art will appreciate that certain variations, alterations, modifications, substitutions and omissions may be made to the embodiments without departing from the spirit of the invention. Accordingly, the foregoing description is meant to be exemplary only, and should not limit the scope of the invention as set forth in the following claims.

What is claimed is:

1. An information technology communications cabinet for electrical substation communications comprising:
an interior defined by a top, a bottom, a back wall, a pair of sidewalls, a front flange and a removable door;
a plurality of network and communications equipment mounted in the interior of the cabinet; and
a plurality of connectors connecting to conduits with cabling to and from the equipment mounted in the interior of the cabinet for connection to and from a power network.

2. The cabinet of claim 1, wherein the cabinet is mounted to a wall or other fixed structure.

3. The cabinet of claim 1, wherein the cabinet is mounted to a fire resistant backboard that is mounted to a wall.

4. The cabinet of claim 1, further comprising a pair of vertical mounting channels attached to the interior back wall of the cabinet for mounting the network and communications equipment thereto.

5. The cabinet of claim 4, further comprising a plurality of mounting brackets adjustably attached to the vertical mounting channels attached to the back wall of the cabinet for mounting the network and communications equipment thereto.

6. The cabinet of claim 4, further comprising a plurality of stand-off mounting straps attached to the vertical mounting channels of the cabinet for mounting horizontal components thereto and for possible securing fiber optic service coil to the inside of the stand-off member

7. The cabinet of claim 1, further comprising a plurality of side mounting straps attached to the inner sidewalls of the cabinet for accepting rack mount hardware thereon.

8. The cabinet of claim 1, wherein the back wall of the cabinet includes a plurality of vertical mounting channels attached thereto for mounting the network and communications equipment by fasteners at a plurality of interchangeable locations.

9. The cabinet of claim 1, wherein the sidewalls include slotted vent openings formed therein for air draw through the cabinet.

10. The cabinet of claim 1, wherein the network and communications equipment includes Ethernet equipment.

11. The cabinet of claim 1, wherein the network and communications equipment includes a fiber optic termination panel.

12. The cabinet of claim 1, wherein the network and communications equipment includes cable management equipment.

13. The cabinet of claim 1, wherein the network and communications equipment includes a surge suppressing power strip.

14. The cabinet of claim 1, further comprising at least one multi-port network access module for accepting a plurality of patch cables.

15. The cabinet of claim 1, wherein the cabling includes power cabling.

16. The cabinet of claim 1, wherein the cabling includes fiber optic cabling.

17. The cabinet of claim 1, wherein the cabling includes Ethernet cabling.

18. The cabinet of claim 1, further comprising an external ground lug connected to the cabinet and including an external grounding wire running from the cabinet to a building grounding system for grounding the cabinet.

19. The cabinet of claim 1, further comprising a fan assembly installed in the top of the cabinet for cooling the cabinet.
